(19) United States
(12) Patent Application Publication
(10) Pub. No.: US 2014/0304075 A1
(43) Pub. Date: Oct. 9, 2014

(54) METHODS AND SYSTEMS FOR TRANSMITTING LIVE COUPONS

(71) Applicants: David Chase Dillingham, Cincinnati, OH (US); Brian William Miller, Mason, OH (US); Samuel Matthew Schottenstein, Cincinnati, OH (US)

(72) Inventors: David Chase Dillingham, Cincinnati, OH (US); Brian William Miller, Mason, OH (US); Samuel Matthew Schottenstein, Cincinnati, OH (US)

(21) Appl. No.: 13/859,663

(22) Filed: Apr. 9, 2013

(51) Int. Cl. G06Q 30/02

(52) U.S. Cl. CPC G06Q 30/0261; G06Q 30/0281
USPC 705/14.58

(57) ABSTRACT

Systems and methods are disclosed for presenting live coupons to a consumer. In embodiments, a method includes receiving profile information associated with a consumer, receiving a live coupon associated with the item sold by the retail store, determining that the consumer is at the location of the item associated with the live coupon by comparing the location of the item with the location of the consumer, and transmitting the live coupon to the consumer responsive to the determination that the consumer is at the location of the item.

### BACKGROUND INFORMATION

1. Field of the Disclosure

The present disclosure relates generally to systems and methods for optimizing a consumer's shopping experience and improving retail store's efficiency. In particular, examples of the present disclosure are related to techniques for presenting time and location based coupons to consumers.

2. Background

Many consumers collect coupons or search through sale announcements when preparing to shop for items such as groceries, office supplies, and household wares. Typically, coupons and/or sale announcements are distributed to shoppers electronically or through the mail. Consumers may spend significant time searching through the coupons and sale announcements in an effort to find deals that reduce the amount of money spent on items or increase the quantity of items received at a given price.

However, conventional coupons that are presented to consumers do not assist the consumer in efficiently shopping while in the retail store. Conventional coupons require the consumer to spend effort searching for coupons as well as locating the items associated with the coupon within the retail store. Further, conventional coupons use predictive mechanisms to determine what items should be put on sale, and conventional coupons do not take into account the retail store's dynamic inventory.

Accordingly, needs exists for more efficient presentation of coupons to consumers to enhance their shopping experience and for retail stores to increase the number of transactions completed while dynamically managing their inventories.

### SUMMARY

Embodiments disclosed herein provide systems and methods allowing consumers to more efficiently and more effectively shop for items within a retail store. Additionally, embodiments disclosed herein provide systems and methods allowing retail stores to more efficiently and more timely present coupons to consumers while dynamically managing their inventories. Embodiments provide benefits to consumers and/or retail stores, improve brand loyalty, and provide a more efficient and enjoyable shopping experience.

Embodiments are configured to present coupons to consumers while shopping so consumers may make real-time cost saving decisions, and allow the retail store to interact with consumers based on information associated with the consumer. Embodiments may be configured to present coupons to consumers based on a profile of the consumer. The coupons may include a location of the item within a retail store, a time period associated with the item, and the item's price. The location may be a text based location, such as an aisle, row, etc. The time period may identify a time limit identifying when the coupon will expire or no longer be valid.

Embodiments may also be configured to allow an associate of the retail store to determine the coupons that are presented to the consumer. The associate of the retail store may be able to set an item associated with the coupon, the location of the item within the retail store, and/or the time period associated with the coupon. Accordingly, embodiments may be configured for retail stores to adjust and/or control the amount of transactions on different days, time periods, and seasons for retail items at a specific retail store. Additionally, embodiments may be configured to allow the retail store to generate coupons for retail items that may have an expiration date, are related to a holiday, or are seasonal items, such that consumers may be timely presented with the coupon before the expiration date, which may reduce, limit, and/or avoid the amount of items that perish or remain unsold.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts one topology for presenting live coupons to consumers of a retail store.

FIG. 2 depicts an embodiment of a block diagram of example components of a consumer computing device.

FIG. 3 depicts an embodiment of a block diagram of example components of a live coupon server.

FIG. 4 illustrates a method for transmitting live coupons to consumers.

FIG. 5 depicts one embodiment of a graphical user interface presented to a consumer.

FIG. 6 depicts one embodiment of a graphical user interface including a map of a retail store and live coupons presented to a consumer.

FIG. 7 depicts one embodiment of a graphical user interface including a map of a retail store and live coupons presented to a consumer.

FIG. 8 depicts one embodiment of a graphical user interface associated with live coupons presented to a consumer.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

In preparation for shopping trips, consumers search for items that they desire to buy, an also generate shopping lists comprised of items the consumers desired to purchase. A profile associated with the consumer may be generated based on the items that the consumer desires to purchase and a location of the consumer. As used herein, the term “item” may refer to groceries, foods, office supplies, clothing wares, or any other fungible good sold by a retail store. As used herein, the term “retail store” may refer to a specific, individual business at a single location, any business, or a combination of businesses that sell items and/or services to a consumer.

To more efficiently complete transactions for the retail store, live coupons may be transmitted to the consumer in response to the consumer's profile and the consumer's location. As used herein, the term “live coupon” may refer to a coupon that expires after a time period and may be based on a location of the item within a retail store. In embodiments, a live coupon may be associated with a perishable item, seasonable item, or any other item that the retail store desires to sell over a given time period. The live coupons may be presented to the consumer as loyalty-based incentives associated with conventional loyalty programs for the retail store.

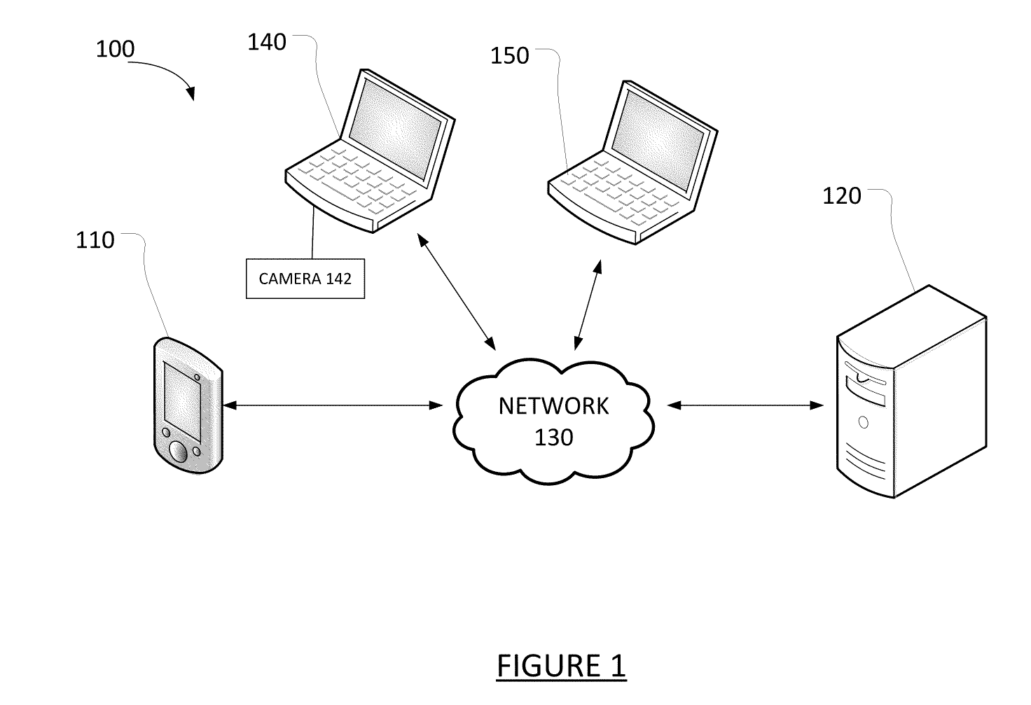

Turning now to FIG. 1, FIG. 1 depicts one topology 100 for presenting live coupons to consumers of a retail store. Topology 100 includes one or more consumer computing devices 110 connected to live coupon server 120, a retail store computing device 140, and/or data sources 150 over network 130.

Network 130 may be a wired or wireless network such as the Internet, an intranet, a LAN, a WAN, a cellular network or another type of network. It will be understood that network 130 may be a combination of multiple different kinds of wired or wireless networks.

Consumer computing device 110 may be a smart phone, tablet computer, laptop computer, personal data assistant, an augmented reality device, such as Google Glasses®, or any other type of mobile device with a hardware processor that is configured to process instructions and connect to network 130, one or more portions of network 130. Consumer computing device 110 may be configured to obtain information from a consumer to generate a consumer profile for the consumer. For example, consumer computing device 110 may be configured to receive demographic information from the consumer, information associated with activities the consumer participates in or enjoys, information associated with the consumer's search history for items carried by the retail store, location information of the consumer, and/or electronic shopping list information associated with items that the consumer desires to purchase from the retail store. Consumer computing device 110 may also be configured to transmit the obtained information to live coupon server 120.

Retail store computing device 140 may be a smart phone, tablet computer, desktop computer, laptop computer, personal data assistant, an augmented reality device, such as Google Glasses®, or any other type of mobile device with a hardware processor configured to process instructions and connect to network 130, one or more portions of network 130. Retail store computing device 140 may be configured to receive and/or transmit information associated with an inventory of the retail store, a map of the retail store, and/or information associated with live coupons to live coupon server 120. The transmitted information may include the location of items within the retail store, in which may be aisle specific or a general location within the retail store responsive to seasonal item placement within the retail store, the number of a specific item currently at the retail store, and/or a price of the item. In embodiments, retail store computing device 140 may transmit and/or receive information associated with a live coupon for an item carried by the retail store. The information associated with the live coupon may include an identifier of the item (e.g. the item's name, bar code identification number, Q-code, etc.), a time period associated with the live coupon identifying when the live coupon may expire (e.g. ten minutes, one hour, one day, close of business, or any other desired time period), a price and/or discount associated with the item (e.g. fifty percent off, the item price is one dollar, the item price is reduced by a dollar, etc.) and/or a location of the item within the retail store (e.g., an aisle number where the item is located, a section of an aisle, such as the first half of the aisle, the side of the aisle the item is located, the location of a category of items, a shelf number where the item is located, coordinates of the item, and/or any other location mechanism identifying the location of the item within the retail store). The information associated with the live coupon may be dynamically generated and/or adjusted by the associate of the retail store. For example, the associate of the retail store may adjust the time period of the live coupon to reduce or extend the expiration period of the live coupon, or if an item has changed locations within the retail store the associate may dynamically change the location of the item for the live coupon, such that consumers may be presented with up-to-date information associated with the live coupon.

In embodiments, the live coupons generated in response to actions performed on retail store computing device 140 may be configured to influence transactions for the retail store and/or influence when consumers shop at the retail store. For example, if a perishable item, such as produce, is about to expire at a specific retail store, retail store computing device 140 may receive information to generate a live coupon for the produce. The generated live coupon may influence consumers to visit the retail store and purchase the produce at a discounted price before the time period associated with the live coupon expires. In embodiments, the time period associated with the live coupon may be correlated to an expiration period of the perishable item.

In other embodiments, the item associated with a live coupon may be a seasonal or holiday related item, and the time period associated with the live coupon may be correlated to a time period associated with the season and/or holiday.

In further embodiments, the live coupon may be associated with a quantity of the items within the inventory of the retail store. In embodiments, a live coupon may be generated for an item if the quantity of the item within the retail store is above or below a quantity threshold. For example, if the quantity of an item at the retail store is above the quantity threshold, a live coupon may be generated for the live coupon and the time period may be associated with a time period until the quantity of the item is below the threshold.

In further embodiments, a live coupon may be generated based on a time period when an item carried by the retail store is set to expire, the quantity of the item at the retail store, and a quantity threshold for the item. In implementations, the quantity threshold may be a determined by empirical evidence for an item, and may be associated with a quantity of the item typically sold and the time period associated with when the item is set to expire. If the quantity the item currently carried by the retail store is above the quantity threshold, then a live coupon may be generated for the item. For example, if an inventory of the retail store indicates that the retail store is carrying a quantity of milk above a milk quantity threshold that the retail store typically will sell over the time period associated with the expiration period of the milk, a live coupon for milk may be generated.

In embodiments, retail store computing device 140 may be an augmented reality processor. The augmented reality processor may be coupled to a camera 142 or any other device configured to record images that can be stored within a memory device or transmitted to another location, such as live coupon server 120. Camera 142 may be a device that can record still images or videos. In one embodiment, camera 142 may be configured to record images of an item or an identifier of the item, such as a bar code, Q-code. Responsive to recording an image, retail store computing device 140 may generate a live coupon for the item. An associate of the retail store may input information associated with the pricing and location of the item for the live coupon via retail store computing device 140, and retail store computing device 140 may transmit the live coupon to live coupon server 120.

Data sources 150 may be sales data companies, manufacturers of items, vendors of items, etc. Data sources 150 may include a hardware processing device configured to transmit and/or receive information associated with an inventory of a retail store, a map of the retail store, and/or live coupons. In embodiments, data sources 150 may track, monitor, transmit, and/or receive inventory information associated with a retail store. Data sources 150 may monitor information associated with quantity of items, pricing information of the items at the retail store, and/or generate live coupons for the items.

Data sources 150 may be configured to influence transaction at a specific retail store for items. Accordingly, data sources 150 may generate and transmit information associated with a live coupon for an item to live coupon server 120. The information associated with the live coupon may be dynamically generated and/or adjusted by data sources 150. For example, data sources 150 may adjust the time period of the coupon to reduce or extend the expiration period of the live coupon. In embodiments, data sources 150 may generate live coupons for promotions for items carried by a retail store. One skilled in the art will appreciate that data sources 150 may be used in collaboration with retail store computing device 140 to generate live coupons for items. In embodiments, a live coupon initially generated by an associate of a retail store by retail store computing device 140 may be modified by data sources 150, and vice versa. Therefore, live coupons may be locally managed at the retail store by retail store computing device 140 and also be managed remotely from the retail store via data sources 150.

Live coupon server 120 may be a computing device such as a general hardware platform server that is configured to support mobile applications, software, computer code stored on a non-transitory computer readable medium, and the like executed on consumer computing device 110, retail store computing device 140, and/or data sources 150. Live coupon server 120 may include physical computing devices residing at a particular location or may be deployed in a cloud computing network environment. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Live coupon server 120 may include any combination of one or more computer-usable or computer-readable media. For example, live coupon server 120 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

Live coupon server 120 may be configured to receive information associated with a retail store from retail store computing device 140 and data sources 150. The received information may include a map of the retail store, pricing of an item for a live coupon, a time period associated with the live coupon, and location information associated with the live coupon. In one embodiment, the live coupon may be associated with an aisle or a general location within the retail store, which may be based on seasonal item placement within the retail store. Live coupon server 120 may be configured to transmit live coupons and information associated with the retail store, such as a map of the retail store and the location of items associated with the live coupons on the map, to consumer computing device 110. Live coupon server 120 may also be configured to obtain profile information including location information associated with a consumer from consumer computing device 110.

In embodiments, live coupon server 120 may be configured to compare the consumer's profile information and the location of the consumer with information associated with live coupons to determine which live coupons are transmitted to what consumers. By comparing the consumer's profile information with the information associated with the live coupon, it may be determined what live coupons the consumer desires to receive or is likely to use. For example, if the consumer's location information matches location information associated with a live coupon, the live coupon may be transmitted to the consumer.

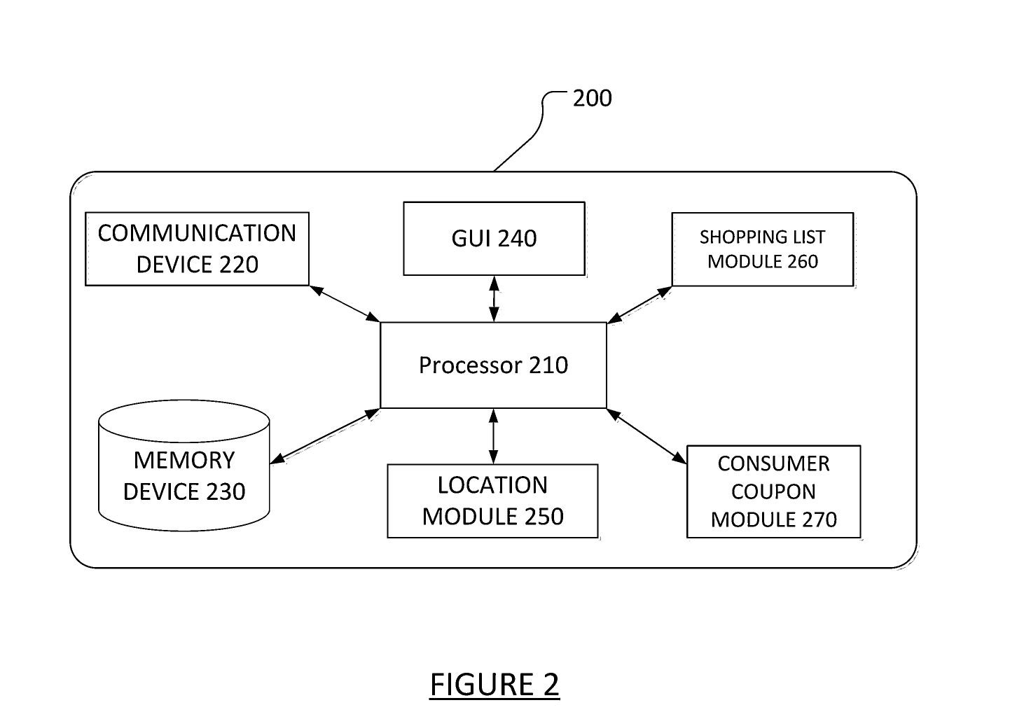

FIG. 2 depicts an embodiment of a block diagram illustrating example components of a consumer computing device 200, which may be a computing device that is, or is similar to consumer computing device 110, as depicting in FIG. 1. Consumer computing device 200 may include a processing device 210, a communication device 220, a memory device 230, a graphical user interface (GUI) 240, a location module 250, a shopping list module 260, and a consumer coupon module 270.

Processing device 210 can include memory, e.g., read only memory (ROM) and random access memory (RAM), storing processor-executable instructions and one or more processors that execute the processor-executable instructions. In embodiments where processing device 210 includes two or more processors, the processors may operate in a parallel or distributed manner. Processing device 210 may execute an operating system of consumer computing device 200 or software associated with other elements of consumer computing device 200.

Communication device 220 may be a device that allows consumer computing device 200 to communicate with another device, e.g., a live coupon server over a network. Communication device 220 may include one or more wireless transceivers for performing wireless communication and/or one or more communication ports for performing wired communication.

Memory device 230 may be a device configured to store data generated or received by consumer computing device 200. Memory device 230 may include, but is not limited to a hard disc drive, an optical disc drive, and/or a flash memory drive.

GUI 240 may be a device that allows a user to interact with consumer computing device 200. While one GUI is shown, the term “user interface” may include, but is not limited to being, a touch screen, a physical keyboard, a mouse, a camera, a video camera, glasses presenting augmented reality to the consumer, a microphone, and/or a speaker. GUI 240 may include inputs where the customer may insert or remove items from a shopping list, enter information associated with what live coupons a consumer desires to receive, enter profile information, enter information associated with live coupons, etc. GUI 240 may include a display configured to present images to the customer on consumer computing device 200, such as a map of the retail store, items on a shopping list, live coupons within the retail store, or further information associated with an item, including but not limited to aisle specific locations. In embodiments, GUI 240 may be configured to present live coupons to the consumer on the display in response to on the location of the consumer within a retail store. For example, a live coupon may be presented to the consumer in response to determining that the consumer is located within a specific aisle of the retail store. In embodiments, the specific aisle of the retail store may be the aisle where an item associated with a live coupon is located within the retail store.

Location module 250 may be configured to determine a location of consumer computing device 210. In embodiments, location module 250 may be configured to continuously determine the location of consumer computing device 210 without receiving commands or inputs from the consumer. As used herein the term “location” may refer generally to a location in a retail store or outside of the retail store, e.g., a location of an item, aisle, a section of an aisle (e.g., the first half of an aisle or a section of the aisle associated with a specific category of items), an item category location within the retail store (e.g., the location of pasta, desert, etc.), or an entrance. A location may be represented in geographic coordinates, Cartesian coordinates, e.g., an (x, y) point if the store is divided into a Cartesian plane, and/or may be represented using reference points, e.g., “aisle 4, 50 feet from the front of the retail store.” Location module 250 may be configured to transmit and/or receive wireless waypoint data to transceivers positioned within the retail store. The wireless waypoint data may include signals such as real-time locating system signals (RTLS), WiFi signals, GPS, Bluetooth, short range radio signals, etc. to determine the location of consumer computing device 210 within a retail store.

Shopping list module 260 may be embodied as processor-executable instructions stored in the memory of the processing device 210, where processing device 210 can execute shopping list module 260. Shopping list module 260 may be configured to utilize GUI 240 to receive inputs associated with items that the consumer desires to purchase, such as a name of an item, a category of an item (e.g., chips, soda, snack food, etc.), or any other identifier of an item. Shopping list module 260 may also be configured to allow a consumer to enter search terms associated with items that the consumer desires to purchase. The items may collectively define a shopping list of items that the consumer desires to complete a transaction for. In embodiments, the consumer may search a database of items carried by a retail store to add items to the shopping list. In response to adding an item on shopping list, further information associated with the item may be presented to the consumer on GUI 240. The further information may include the name of the item, a live coupon associated with the item, a price of the item, substitute items, complimentary items, inventory status, etc. Shopping list module 260 may also be configured to determine the location of the items on the shopping list in the retail store, determine an optimal route for the consumer (e.g., fastest time, shortest distance, etc.) to locate each item within the shopping list and present the optimal route to the consumer. The optimal route for the consumer within the retail store may be dynamically adjusted by shopping list module 260 in response to the consumer adding and/or removing an item from the shopping list. In further embodiments, shopping list module 260 may be configured to compare the prices of items within the shopping list for the retail store with the prices of the items within the shopping list at other retail stores, and present the price differences on GUI 240.

Consumer coupon module 270 may be embodied as processor-executable instructions stored in the memory of the processing device 210, where processing device 210 can execute consumer coupon module 270. Consumer coupon module 270 may be configured to generate a profile for the consumer in response to the consumer entering consumer information on GUI 240, such as searching for items or completing a shopping list, and location module 250 determining the location of the consumer. The profile may be stored within memory device 230, or at a remote location, such as a live coupon server. The profile information may include information associated with items the consumer desires to purchase and/or items the consumer desires to receive live coupons for. In embodiments, the consumer may enter information to generate a profile for the consumer, the profile may include categories of items that the consumer is likely to purchase (e.g., pop, snack food, etc.), activities the consumer participates in and/or enjoys (e.g., sports, outdoor activities, reading, etc.) a specific item, (e.g., pepsi soda), a brand of items the consumer is likely to purchase, items the consumer searched for associated with the retail store, items within a shopping list, and/or items the consumer may want further information about. In response to receiving the profile and location information associated with the consumer, consumer coupon module 270 may transmit the consumer information to the live coupon server. The live coupon server may compare the profile information and the location of the consumer with live coupon information to determine live coupons to transmit to the consumer. Consumer coupon module 270 may receive the live coupons and present information associated with the live coupon to the consumer on GUI 240. The live coupon information presented to the consumer on GUI 240 may include a name of an item, a price associated with the item, a map of the retail store, a location of the item of the map, and a time limit associated with the live coupon.

In embodiments, consumer coupon module 270 may be configured to include retail stores that the consumer desires to receive live coupons for in the profile associated with the consumer. Consumer coupon module 270 may be configured to determine the location of consumer computing device 200 via location module 250 to determine a list of retail stores in close proximity to the consumer. Consumer coupon module 270 may present the list of retail store in close proximity to the consumer on GUI 240. Utilizing GUI 240, the consumer may select which retail stores the consumer desires to receive live coupons for. In embodiments, coupon module 270 may be configured to determine retail stores that the consumer desires to receive live coupons for in response to retail stores that the consumer visits. For example, utilizing location module 250, consumer coupon module 270 may determine what retail stores the consumer has visited and how many times the consumer has visited a retail store. If the number of times that the consumer has visited a retail store is greater than a count threshold, which may be any desired number determined via empirical evidence, then consumer coupon module 270 may determine that the consumer frequently visits the retail store. Responsive to a determination that the consumer frequently visits a retail store, the retail store may be added to the list of retail stores within the consumer's profile that the consumer desires to receive live coupons for. In embodiments, the consumer may select retail stores to add to the consumer's profile and/or receive live coupons for via free form typing or any other known selection mechanism.

In embodiments, consumer coupon module 270 may also be configured to receive information, such as live coupons, associated with items that may be substitutes and/or complements to items on the shopping list from a live coupon server. For example, in response to shopping list module 260 transmitting a shopping list to a live coupon server, the live coupon server may determine items that are substitutes with an item associated with a live coupon, determine items that are substitutes of an item on the shopping list, determine items that are complimentary items with live coupons, and determine items that are complementary items to items on the shopping list. Responsive to determining substitute items and/or complimentary items for items on the consumer's shopping list, consumer coupon module 270 may receive information associated with the live coupons for items that are substitute items and/or complimentary items and present the information to the consumer on GUI 240.

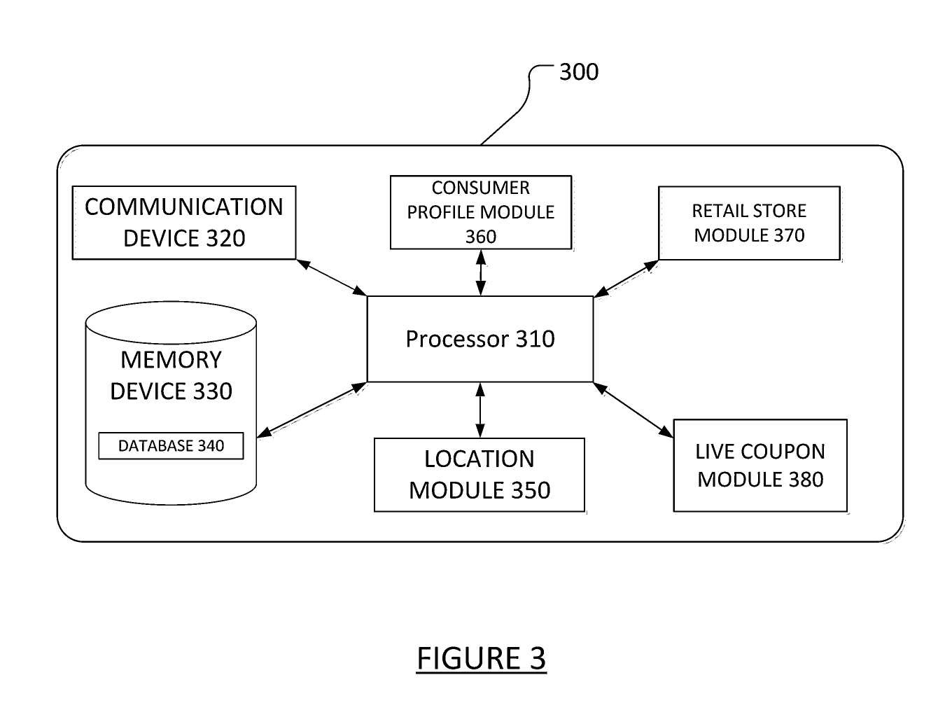

FIG. 3 depicts an embodiment of a block diagram depicting example components of a live coupon server 300, which may be a computing device that is, or is similar to live coupon server 130, as depicting in FIG. 1.

Live coupon server 300 may include a processing device 310, a communication device 320, a memory device 330, a location module 350, a consumer profile module 360, a retail store module 370, and live coupon module 380.

Processing device 310 may include memory, e.g., read only memory (ROM) and random access memory (RAM), storing processor-executable instructions and one or more processors that execute the processor-executable instructions. In embodiments where processing device 310 includes two or more processors, the processors may operate in a parallel or distributed manner. Processing device 310 may execute an operating system of live coupon server 300 or software associated with other elements of live coupon server 300.

Communication device 320 may be a device that allows live coupon server 300 to communicate with another device, e.g., a consumer computing device, a retail store computing device, and/or data sources over a network. Communication device 320 may include one or more wireless transceivers for performing wireless communication and/or one or more communication ports for performing wired communication. In embodiments, communication device 320 may be configured to receive profile information associated with a consumer, location information of the consumer within a retail store, information associated with a map of the retail store, live coupon information, and/or information associated with an inventory of the retail store. Responsive to processing device 310 comparing information received from the consumer computing device and the information received from data sources and/or the retail store computing device, communication device 320 may transmit live coupons to the consumer computing device.

Memory device 330 may a device that stores data generated, transmitted, or received by live coupon server 300. Memory device 330 may include, but is not limited to being a hard disc drive, an optical disc drive, and/or a flash memory drive. Memory device 330 may be accessible to the processing device 300. In embodiments, memory device 330 may be configured to store information associated with location module 350, consumer profile module 360, retail store module 370, and live coupon module 380. In one embodiment, memory device 330 may store location information for location module 350 corresponding to the location of the consumer, the location of items within the retail store, and map information identifying a map of the retail store. Memory device 330 may also store the profile of consumers for consumer profile module 360, information associated with live coupons for retail store coupon module 370, and information associated with live coupons for live coupon module 380.

In embodiments memory device 330 may store a database 340 including profile entries for each consumer operating a consumer client device. The profile entry for the consumer may include profile information associated with the consumer, such as demographic information of the consumer, a location or past locations of the consumer, categories of items that the consumer desires to receive live coupons for, activities the consumer participates in, a history of items that the consumer searched for, items the consumer adds to a shopping list, specific brands and/or items that the consumer desires to purchase or may desire to purchase.

Database 340 may be configured to store maps corresponding to the layout of retail stores. Memory device 330 may receive a map of the retail store from a plurality of sources such as the retail store, a partner of the retail store, the internet, or any other source of map information. In response to receiving the map of the retail store, the map may be stored within database 240. In embodiments, database 340 may include maps that comprise a specific layout of a retail store including item placement indicators, size of different departments, and/or aisles of the retail store.

Database 340 may also be configured to store entries associated with live coupons. Each live coupon entry within database 340 may include an identifier associated with an item, a location of the item, a time period associated with when the live coupon may expire, price information associated with the item, a category of the item associated with the live coupons, and/or activities associated with the live coupon. In implementations, profile entries may be compared live coupon entries to determine what consumers receive what live coupons.

Database 340 may also be configured to store identifiers for items that are substitutes and/or complementary items to items carried by the retail store. Database 340 may store potential substitutes and/or complementary items for a plurality of different items. In embodiments, a substitute for an item may be one or more substitute items that could serve as a substitute and/or replacement for the item. For example, a first brand of soda may be a potential substitute for a second brand soda. The potential substitutes may be determined and subsequently stored within database 340 in any suitable manner. Further, substitute items may be based on the consumer's profile. For example, if the consumer's profile identifies the consumer as a consumer of legal drinking age, then a substitute for soda may be an adult beverage. Whereas, if the consumer's profile identifies the consumer as a teenager, then a substitute for soda may be juice. In embodiments, an associate of a retail store and/or other data sources may transmit what items are substitute items. In embodiments, a complimentary item may be one or more items that may likely be purchased along with another item. The potential complimentary items may be determined and subsequently stored within database 340 in any suitable manner. For example, pizza may be determined as a complimentary item for beer. Similarly to substitutes for items, complimentary items may be determined in response to the consumer's profile. In embodiments, an associate of a retail store and/or other data sources may transmit what items are complimentary items for the items. Therefore, an associate of a specific retail store and/or data sources associated with a plurality of retail stores may dynamically adjust, modify, or change what items are potential substitutes and/or complementary items of items. Additionally, live coupon server 300 may be configured to dynamically determine complementary items based on standard product or consumer purchasing analysis. The standard product or consumer purchasing analysis may be determined based on historical data associated with the consumer or other consumer purchasing items.

Location module 350 may be configured to receive location information from a consumer computing device to determine a location of a consumer within the retail store. Location module 350 may also be configured to receive location information associated with the locations of items within a retail store. Location module 350 may determine the location of a consumer computing device via any known means, such as a RTLS WiFi, radar, mobile device tracking, time distance of arrival (TDOA) signals, short wave radio, Bluetooth, etc. Location module 350 may perform known triangulation techniques to determine the current location of a consumer computing device within a retail store. In one example embodiment, to determine a location of a consumer within a retail store, location module 350 may transmit and receive location signals to transceivers positioned throughout a retail store and/or a consumer computing device. In response to transmitting location signals to the transceivers, location module 350 may receive location data to determine the current location of the consumer computing device. The current location of the consumer may be determined in real-time and stored within database 340.

Consumer profile module 360 may be embodied as processor-executable instructions stored in the memory of the processing device 310, where processing device 310 can execute consumer profile module 360. Consumer profile module 360 may be configured to receive information from a consumer computing device to generate a profile for the consumer. For example, live coupon server 300 may be configured to receive demographic information from the consumer, preference information from the consumer, search information associated with the consumer's searching items carried by a retail store, the location of a consumer within the retail store, activities the consumer enjoys and/or participates in, and/or electronic shopping list information associated with items that the consumer desires to purchase. Responsive to receiving the profile information from a consumer computing device, consumer profile module 360 may generate and/or update a profile entry associated with the consumer within database 340. The profile of the consumer may be utilized to determine which live coupons the consumer desires to receive.

Retail store module 370 may be embodied as processor-executable instructions stored in the memory of the processing device 310, where processing device 310 can execute retail store module 370. Retail store module 370 may be configured to receive, transmit and/or store information associated with live coupons. In embodiments, responsive to receiving a live coupon from a retail store or data source, retail store module 370 may generate and/or update an entry within database 340 for the live coupon. The entry within database 340 for the live coupon may include an identifier, name, or tag of the item, a time period associated with the live coupon identifying when the live coupon may expire, a quantity of items, a category of associated with the item, activities associated with the item, a price and/or discount associated with the item, and/or a location of the item within the retail store. In embodiments, the tag of the live coupon may correspond to entries within the consumer's profile identifying if the consumer desires to receive a live coupon associated with the item. In embodiments, the live coupon may have a tag with information associated with the brand, category of product, substitute items, complimentary items, gender related information, activity related information, etc. The tag may be compared with information within consumers' profile, and if the tag matches profile information, the live coupon associated with the tag may be transmitted to the consumer.

Live coupon module 380 may be embodied as processor-executable instructions stored in the memory of the processing device 310, where processing device 310 may execute live coupon module 380. Live coupon module 380 may be configured to compare information within an entry for a consumer's profile stored within database 340 with information associated with a live coupon within database 340, such as the tag of the live coupon. Responsive to comparing the information, live coupon module 380 may determine whether to transmit a live coupon to a consumer computing device. For example, live coupon module 380 may compare information associated with a category of item that a consumer desires to receive information about with a category of an item associated with a live coupon. If the category of the item of the live coupon matches a category within the consumer's profile, then live coupon module 380 may transmit the live coupon to the consumer computing device.

In embodiments, live coupon module 380 may be configured to compare the received location information identifying the location of the consumer within the retail store with the location information associated with an item for a live coupon. Live coupon module 380 may determine if the consumer is within an aisle or within close proximity to the location of an item associated with the live coupon. Responsive to determining that the consumer is within an aisle or in close proximity to an item associated with a live coupon, live coupon module 380 may transmit the live coupon to the consumer's computing device. For example, if a live coupon is associated with an item located at aisle four of a retail store, responsive to the consumer being located at aisle four of the retail store, the live coupon with the item located at aisle four may be transmitted to the consumer's client device. In further embodiments, only live coupons with information corresponding to information within a consumer's profile may be transmitted to the consumer's client device.

In embodiments, live coupon module 380 may be configured to query database 340 to determine if there are live coupons associated with substitute and/or complimentary items associated with the consumer's profile. Responsive to determining that there are substitute and/or complimentary items associated with the consumer's profile, live coupon module 380 may transmit the live coupons of the substitute and/or complimentary items to the consumer's computing device.

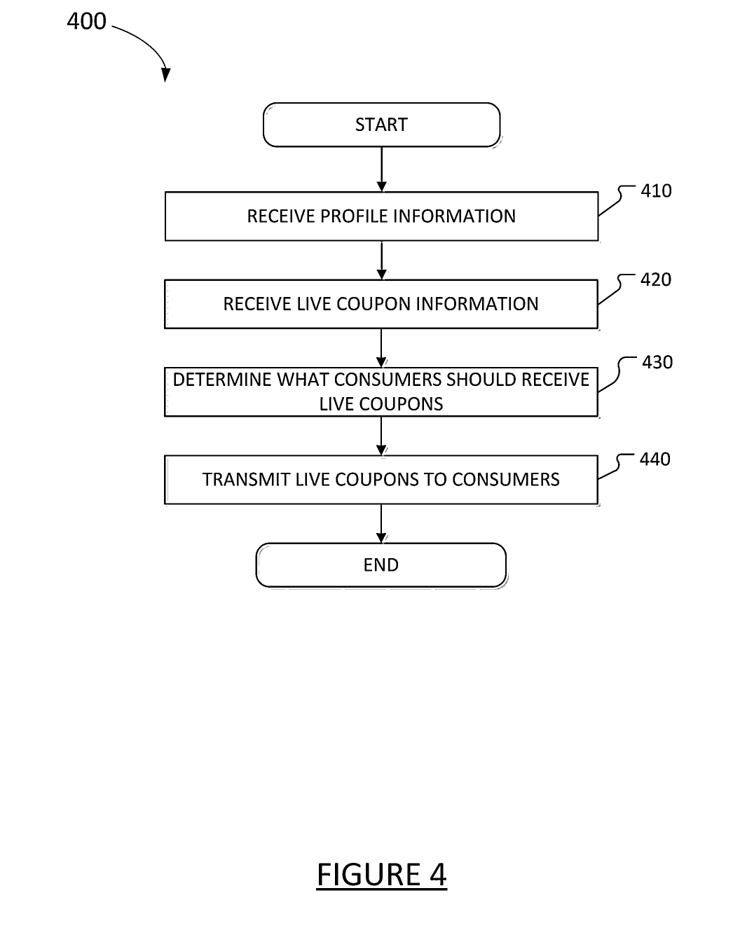

FIG. 4 illustrates a method 400 for transmitting live coupons to consumers. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At operation 410, profile information associated with a consumer may be received. The consumer profile information may include demographic information of the consumer, preference information of the consumer, activities the consumer participates in or enjoys, search information associated with the consumer's searching for items carried by a retail store, the location of the consumer within the retail store, and/or electronic shopping list information associated with items that the consumer desires to purchase from the retail store. The received profile information may be stored in a database. Operation 410 may be performed by a location module and/or a consumer profile module that is the same as or similar to user location module 350 and/or consumer profile 360, in accordance with one or more implementations.

At operation 420, information associated with live coupons may be received. The live coupons may be associated with items carried by a specific retail store. The live coupons may include information including an identifier of the item, a time period associated with the live coupon identifying when the live coupon may expire, a price and/or discount associated with the item and/or a location of the item within the retail store. The live coupons may include information configured to be compared to information within a consumer's profile to determine what consumers may receive which live coupons. The information associated with the live coupons may be dynamically generated by an associate of a specific retail store and/or other data sources. Therefore, the associate of the specific retail store may generate live coupons for the specific retail store to adjust the inventory at the specific retail store, such as generating live coupons for perishable items, seasonal items, and/or holiday related items carried by the retail store that may expire. Operation 420 may be performed by a retail store computer module that is the same as or similar to retail store computer module 370, in accordance with one or more implementations.

At operation 430, it may be determined what consumers should receive what live coupons. The determination may be made responsive to comparing consumer profile information with live coupon information. It may be determined that a consumer may receive a live coupon if the information within a consumer's profile matches the information associated with the live coupon. For example, if a consumer's profile indicates that the consumer is at a first aisle within a retail store and the live coupon includes location information indicating that the item is within the first aisle of the retail store, the live coupon may be transmitted to the consumer. Operation 430 may be performed by a live coupon module that is the same as or similar to live coupon module 380, in accordance with one or more implementations.

At operation 440, the live coupon with information corresponding to information within the consumer's profile may be transmitted and presented to the consumer. The consumer may view the live coupon and add the item corresponding to the live coupon to an electronic shopping list. In embodiments, the live coupon may also be added to the consumer's electronic shopping list. Operation 440 may be performed by a live coupon module that is the same as or similar to live coupon module 380, in accordance with one or more implementations.

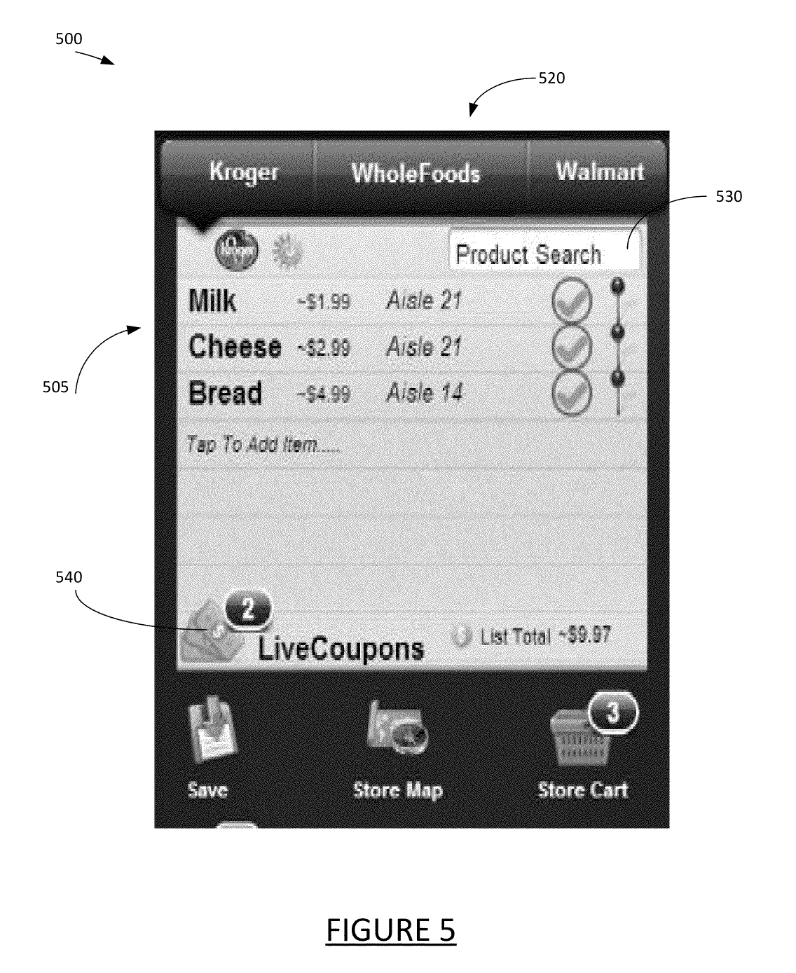

FIG. 5 depicts one embodiment of a graphical user interface 500 presented to a consumer. The graphical user interface 500 may include selectable buttons 520 configured to allow the consumer to select a specific retail store and/or a chain of retail stores that the consumer desires to be presented live coupons with and/or retail stores that the consumer desires to generate an electronic shopping list 505 for.

Graphical user interface 500 may also include a search field 530, where the consumer may generate search terms to search for items that the consumer desires to add to their shopping list 505. In embodiments, the consumer may add generic categories of items, such as milk, cheese, and bread, and/or specific brands of the items within the category. Responsive to selecting an item to be included in the electronic shopping list, information corresponding to the item, such as a name of the item, price of the item, current inventory status, and location of the item may be presented to the consumer.

Graphical user interface 500 may also include an indicator 540 indicating available live coupons associated with items within shopping list 505 for the selected retailer. In embodiments, the consumer may utilize selectable buttons 520 to select another retail store, maintain and/or add items to electronic shopping list 505. Responsive to selecting a new retail store utilizing selectable buttons 520, indicator 540 may present information associated with live coupons for the newly selected retail store to the consumer.

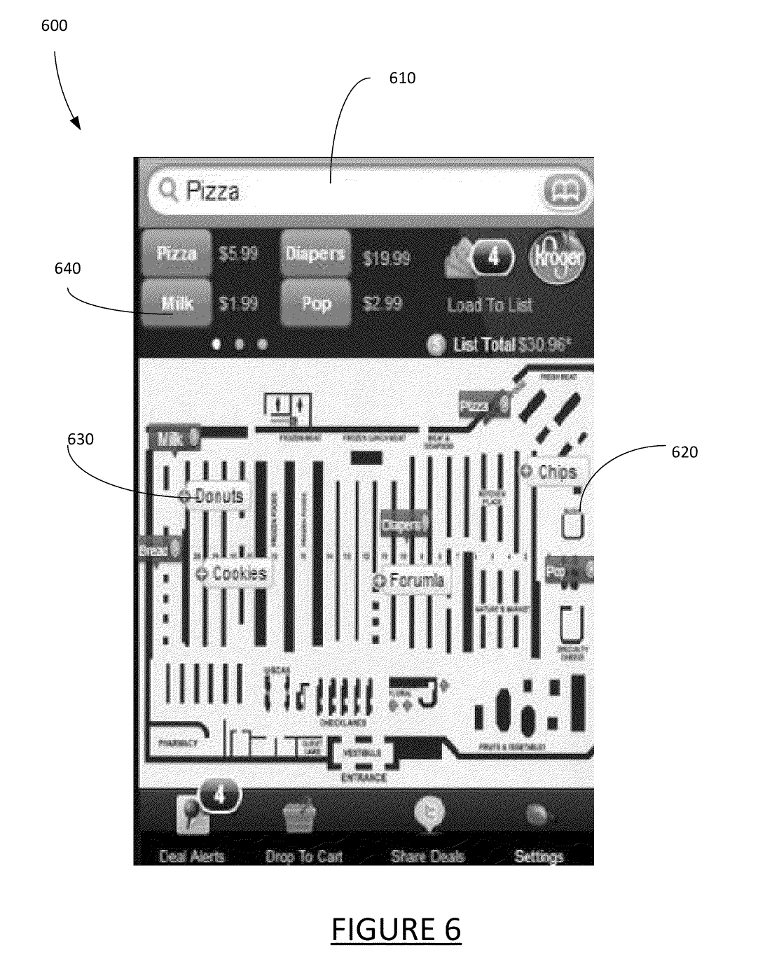

FIG. 6 depicts one embodiment of a graphical user interface 600 presented to a consumer. Graphical user interface 600 may present a search field 610, map 620, live coupons 630, and/or electronic shopping list 640 to consumers.

Search field 610 may be configured to allow consumers to search for items carried by a retail store, and add searched items to electronic shopping list 640.

Map 620 may present a layout of a retail store to the consumer. Map 620 may include information associated with aisles of the retail store and information associated with the location of items within the retail store. Presented along with map 620, may be indicators of live coupons 630 associated with items within shopping list 640. Live coupons 630 may be superimposed on map 620 at the location of their corresponding items. In addition to presenting live coupons 630 associated with items within shopping list 640, graphical user interface 600 may also present live coupons 630, at their corresponding locations, to the consumer for items that are substitutions and/or complimentary items to items within shopping list 640 to the consumer.

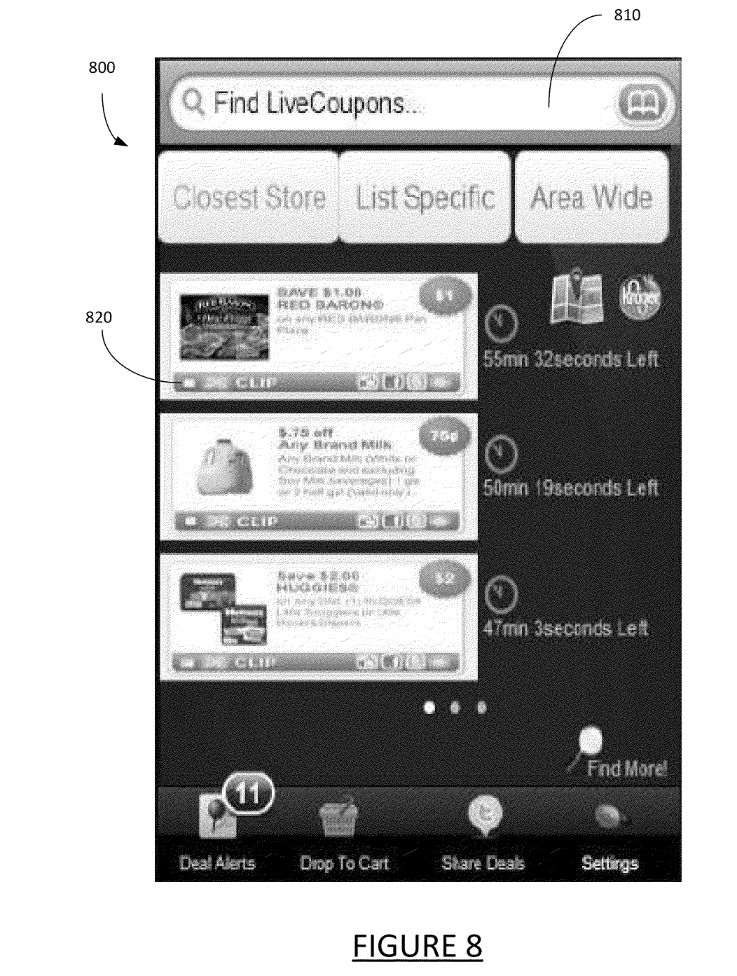

Live coupons 630 may be selectable live coupons. Responsive to a consumer selecting live coupons 630, graphical user interface 600 may present further information associated with the live coupons, as depicted in FIG. 8, to the consumer.

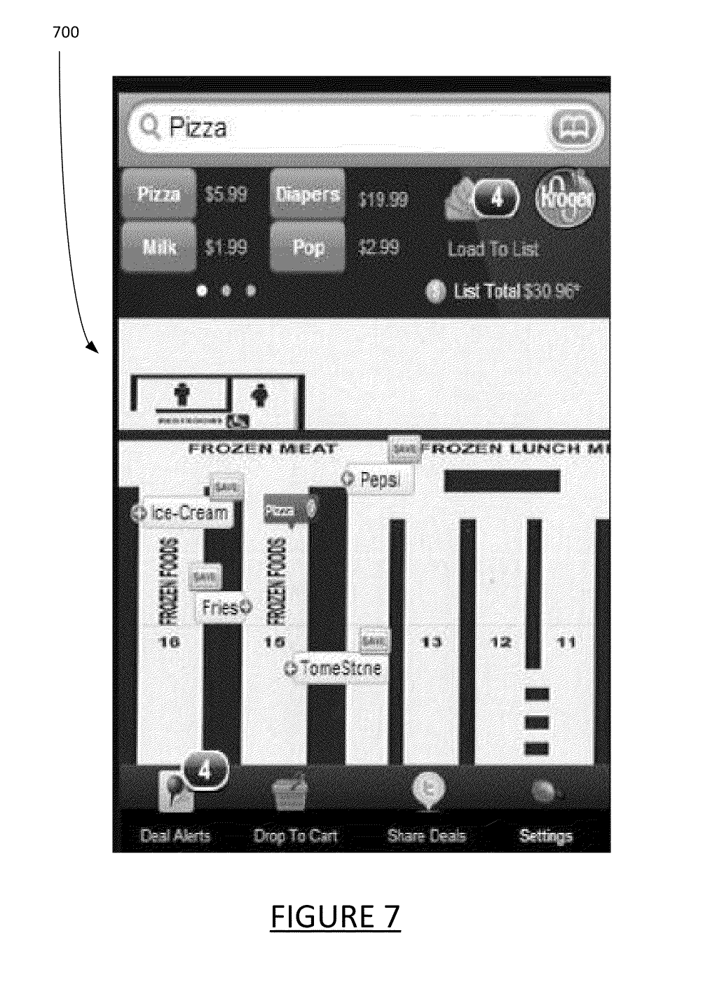

Graphical user interface 600 may also be configured to receive actions from the consumer to zoom in or out on map 620. Responsive to the consumer performing actions on graphical user interface 600 to zoom in, a zoom-in map 700 as depicted in FIG. 7 may be presented to the consumer.

Zoom-in map 700 may present more specific information associated the live coupons 630 to the consumers. The more specific information may include, but is not limited to, a more specific location of the item within the retail store, and a button where the consumer may add a live coupon to the consumer's electronic shopping list.

FIG. 8 depicts one embodiment of a graphical user interface 800 associated with live coupons presented to a consumer.

Graphical user interface 800 may include search field 810 and live coupons 820. Graphical user interface 800 may be presented to a consumer responsive to a consumer selecting a button to receive further information associated with a live coupon. Responsive to the consumer selecting the button associated with a live coupon, graphical user interface 800 may present to the consumer live coupons associated with the items within the electronic shopping list and live coupons associated with complementary and/or substitute items within the consumer's shopping list.

Search field 810 may be configured to allow consumers to search for additional items carried by a retail store to be presented with live coupons associated with the searched items.

Live coupons 820 may present information associated with coupons for items carried by the retail store. The information presented to the consumer may include a checkmark indicator indicating if the item is in stock, a timer indicating the time period when the live coupon will expire, and a price reduction identifier identifying the price reduction of the item.

In embodiments, graphical user interface 800 may present live coupons associated with a specific retail store, a selected retail store (e.g. the closest retail store), a set of retail store (e.g., selected retail stores within the consumer's profile), or area wide retail stores including all retail stores within a given area. Accordingly, the consumer may determine to receive live coupons with specific retail stores or a set of retail stores.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A computer-implemented method comprising:
receiving, at a processing device, profile information associated with a consumer, the profile information including information associated with an item sold by a retail store and location information based on a location of the consumer within the retail store;
receiving, at the processing device, a live coupon associated with the item sold by the retail store, the live coupon including a price of the item, a location of the item within the retail store, and an expiration period of the live coupon;
determining, at the processing device, that the consumer is at the location of the item associated with the live coupon by comparing the location of the item with the location of the consumer;
transmitting, at the processing device, the live coupon responsive to the determination that the consumer is at the location of the item.

2. The method of claim 1, wherein the location of the item is an aisle of the retail store.

3. The method of claim 1, wherein the item is a perishable item carried by the retail store and the expiration period of the live coupon is associated with a time period that the item will perish.

4. The method of claim 1, further comprising:
determining, at the processing device, a substitute item for the item, the substitute item being at least one of a substitute item for the item or a complimentary item for the item,
receiving, at the processing device, a second live coupon associated with the substitute item sold by the retail store, the live coupon including a price of the substitute item, a location of the substitute item, and an expiration period of the second live coupon;
determining, at the processing device, that the consumer is at the location of the substitute item by comparing the location of the substitute item with the location of the consumer;
transmitting, at the processing device, the second live coupon responsive to the determination that the consumer is at the location of the substitute item.

5. The method of claim 1, wherein the live coupon is associated with the item sold by a specific retail store, the specific retail store being an individual retail store.

6. The method of claim 1, further comprising:
comparing, at the processing device, the profile information of the consumer with the live coupon information, the profile information of the consumer including a category of products the consumer desires to purchase and the live coupon information including a category of products associated with the item; and
determining, at the processing device, to transmit the live coupon responsive to the comparison of the profile information with the live coupon information.

7. The method of claim 1, further comprising:
receiving, at the processing device, map information associated with the retail store, the map information being a layout of the retail store including identifiers of aisles and locations of items within the aisles.

8. The method of claim 7, further comprising:
transmitting, at the processing device, the map including the location of the item associated with the live coupon superimposed on the map.

9. The method of claim 1, further comprising:
receiving, at the processing device, information from an associate of the retail store to dynamically adjust the live coupon, wherein the associate of the retail store is physically located at the retail store.

10. A system for presenting live coupons to consumers, the system comprising:
one or more processors configured to execute computer program modules, the computer program modules including,
a consumer profile module configured to receive profile information associated with a consumer, the profile information including information associated with an item sold by a retail store and location information based on a location of the consumer within the retail store;
a retail store module configured to receive a live coupon associated with the item sold by the retail store, the live coupon including a price of the item, a location of the item within the retail store, and an expiration period of the live coupon;
a live coupon module configured to determine that the consumer is at the location of the item associated with the live coupon by comparing the location of the item with the location of the consumer, the live coupon module being further configured to transmit the live coupon responsive to the determination that the consumer is at the location of the item.

11. The system of claim 10, wherein the location of the item is an aisle of the retail store.

12. The system of claim 10, wherein the item is a perishable item carried by the retail store and the expiration period of the live coupon is associated with a time period that the item will perish.

13. The system of claim 10, wherein the live coupon module is further configured to:
determine a substitute item for the item, the substitute item being at least one of a substitute item for the item or a complimentary item for the item;
receive a second live coupon associated with the substitute item sold by the retail store, the live coupon including a price of the substitute item, a location of the substitute item, and an expiration period of the second live coupon;
determine that the consumer is at the location of the substitute item by comparing the location of the substitute item with the location of the consumer; and
transmit the second live coupon responsive to the determination that the consumer is at the location of the substitute item.

14. The system of claim 10, wherein the live coupon is associated with the item sold by a specific retail store, the specific retail store being an individual retail store.

15. The system of claim 10, wherein the live coupon module is further configured to compare the profile information of the consumer with the live coupon information, the profile information of the consumer including a category of products the consumer desires to purchase and the live coupon information including a category of products associated with the item; and
determine to transmit the live coupon responsive to the comparison of the profile information with the live coupon information.

16. The system of claim 10, wherein the retail store module is further configured to:
receiving map information associated with the retail store, the map information being a layout of the retail store including identifiers of aisles and locations of items within the aisles.

17. The system of claim 16, wherein the live coupon module is further configured to transmit the map information including the location of the item associated with the live coupon superimposed on the map.

18. The system of claim 10, wherein the retail store module is further configured to receive information from an associate of the retail store to dynamically adjust the live coupon, the associate of the retail store being physically located at the retail store.

19. A system for presenting live coupons to consumers, the system comprising:
one or more processors configured to execute computer program modules, the computer program modules including,
a location module configured to determine a location of a consumer within a retail store;
a shopping list module configured to generate a shopping list for the consumer in response to consumer interactions with a graphical user interface, the shopping list including at least one item;
a consumer coupon module configured to receive a live coupon associated with the item carried by the retail store responsive to the location of the consumer within the retail store and the location of item within the retail store, the location of the item and the location of the consumer being an aisle of the retail store, and the live coupon including an expiration period, wherein the item is a perishable item and the expiration period being associated with when the item will perish.

20. The system of claim 19, wherein the consumer coupon module is further configured to present live coupons for items that are substitute and complementary items to the item to the consumer.
